(19) United States
(12) Patent Application Publication
(10) Pub. No.: US 2024/0085583 A1
(43) Pub. Date: Mar. 14, 2024

(54) SYSTEM AND METHOD FOR DETERMINATIONS ASSOCIATED WITH PIPE ECCENTRICITY

(71) Applicant: Baker Hughes Oilfield Operations LLC, Houston, TX (US)

(72) Inventors: Jose Mauricio Garcia Roman, Magnolia, TX (US); Joseph Olaiya, Houston, TX (US); Baoyan Li, Houston, TX (US); Sebastien Kamgang, Houston, TX (US); Douglas Patterson, Magnolia, TX (US); Sushant Dutta, Sugar Land, TX (US)

(73) Assignee: Baker Hughes Oilfield Operations LLC, Houston, TX (US)

(21) Appl. No.: 18/244,028

(22) Filed: Sep. 8, 2023

Related U.S. Application Data
(60) Provisional application No. 63/405,826, filed on Sep. 12, 2022.

(51) Int. Cl. G01V 1/50

(52) U.S. Cl. CPC G01V 1/50; G01V 2001/526

(57) ABSTRACT

A system for determinations associated with pipe eccentricity in a downhole environment includes a downhole tool having first transducers to provide first shear horizontal waves to the downhole environment and second transducers to provide first Lamb waves to the downhole environment, and includes memory storing instructions and a processor to execute the instructions from the memory to cause the system to receive, using the first transducers, second shear horizontal waves returned from the downhole environment and to receive, using the second transducers, second Lamb waves returned from the downhole environment, and further to determine shear horizontal third-interface echoes (TIEs) or Lamb TIEs from the second shear horizontal waves or the second Lamb waves and to determine the pipe eccentricity of the casing based in part on the one or more of the shear horizontal TIEs or the Lamb TIEs.

### CROSS-REFERENCES TO RELATED APPLICATIONS

This application is related to and claims the benefit of priority from U.S. Provisional Application 63/405,826, titled SYSTEM AND METHOD FOR DETERMINATIONS ASSOCIATED WITH PIPE ECCENTRICITY, filed Sep. 12, 2022, the entire disclosure of which is incorporated by reference herein for all intents and purposes.

### BACKGROUND

### 1. Field of Invention

The disclosure herein relates in general to equipment used in the natural oil and gas industry, and in particular, to a system and a method for determinations associated with pipe eccentricity in a downhole environment.

### 2. Description of the Prior Art

Determination of pipe eccentricity may benefit evaluation of cement-bonding quality and identification of isolation zones of a cased-hole well. Particularly, for plugged and abandoned (P&A) wells, knowledge of pipe eccentricity may be useful to address any physical shortcomings therein. A variety of sonic and ultrasonic logging tools may be used for cement evaluation. Sonic logging tools may include variable density log tool (VDL) and cement bond log tool (CBL). These tools excite and receive waves in the pitch-catch mode. CBL tools may also include segmented bond tools (SBTs) and radial bond tools (RBTs) as further types of tools used in such procedures. Ultrasonic tools for cement evaluation may generate and acquire ultrasonic waves in one or more of a pitch-catch mode and a pulse-echo mode. Further, pitch-catch, as used with respect to a pitch-catch mode pertains to aspects of a method and system adapted for wave generation and for wave acquisition using different transducers that are spaced apart. Still further, pulse-echo, as used with respect to a pulse-echo mode pertains to wave generation and wave acquisition performed together by the same transducer.

### SUMMARY

In at least one embodiment, a method for determining pipe eccentricity in a downhole environment includes providing a downhole tool including one or more first transducers to provide first shear horizontal waves and including one or more second transducers to provide first Lamb waves. The method includes running the downhole tool into a casing to the downhole environment. The method includes receiving, using the one or more first transducers, second shear horizontal waves that are associated with the first shear horizontal waves and that are returned from the downhole environment. Further, the method includes receiving, using the one or more second transducers, second Lamb waves that are associated with the first Lamb waves and that are returned from the downhole environment. The method also includes determining, using a processor executing instructions from a memory, shear horizontal third-interface echoes (TIEs) or Lamb TIEs from the second shear horizontal waves or the second Lamb waves. The method additionally includes determining the pipe eccentricity of the casing based in part on the one or more of the shear horizontal TIEs or the Lamb TIEs.

In at least one embodiment, a system for determining pipe eccentricity in a downhole environment includes a downhole tool having one or more first transducers to provide first shear horizontal waves to a downhole environment and having one or more second transducers to provide first Lamb waves to the downhole environment. The system includes memory storing instructions and a processor to execute the instructions from the memory to cause the system to perform functions. The functions include using the one or more first transducers to receive second shear horizontal waves that are associated with the first shear horizontal waves and that are returned from the downhole environment and using the one or more second transducers to receive second Lamb waves that are associated with the first Lamb waves and that are returned from the downhole environment. A further function is to determine, using a processor executing instructions from a memory, shear horizontal third-interface echoes (TIEs) or Lamb TIEs from the second shear horizontal waves or the second Lamb waves. Yet another function is to determine the pipe eccentricity of the casing based in part on the one or more of the shear horizontal TIEs or the Lamb TIEs.

In at least one embodiment, another system herein includes one or more processors to determine a pipe eccentricity of a casing in a downhole environment based in part on the one or more of shear horizontal third-interface echoes (TIEs) or Lamb TIEs. The shear horizontal TIEs or the Lamb TIEs is determined from received shear horizontal waves or received Lamb waves. The received shear horizontal waves is from one or more first transducers and the received Lamb waves is from the one or more second transducers. The one or more first transducers are to provide shear horizontal waves from a downhole tool into the casing of the downhole environment and to cause the received shear horizontal waves. Further, the one or more second transducers are to provide Lamb waves from the downhole tool into the casing and to cause the received Lamb waves.

### BRIEF DESCRIPTION OF THE DRAWINGS

Various embodiments in accordance with the present disclosure will be described with reference to the drawings, in which:

FIG. 1 illustrates an example downhole environment subject to determinations associated with pipe eccentricity in a downhole environment, in at least one embodiment herein;

FIG. 2 illustrates a section of a system for determinations associated with pipe eccentricity in a downhole environment of at least one embodiment herein;

FIG. 3 illustrates further aspects of a system for determinations associated with pipe eccentricity in a downhole environment of at least one embodiment herein;

FIG. 4 illustrates waveform features of a method for determinations associated with pipe eccentricity in a downhole environment of at least one embodiment herein;

FIGS. 5A-D illustrate methods for determinations associated with pipe eccentricity in a downhole environment, in different embodiments; and

FIG. 6 illustrates a system for determinations associated with pipe eccentricity in a downhole environment, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described. Various other functions can be implemented within the various embodiments as well as discussed and suggested elsewhere herein.

In at least one embodiment, methods and systems for determinations associated with pipe eccentricity in a downhole environment include the use of a downhole tool having first transducers and second transducers in a same normal plane or in different normal planes with respect to an axis of a barrier. The pipe eccentricity pertains to at least one distance between centers of two barriers (such as two casing or a casing and a formation) and can be determined from distances between barriers at two different sectors or sides of the barriers.

The distances between the barriers inform a reviewer that a first pipe that is concentric with second pipe or that is adjacent to a downhole environment is too close on one sector or side as against its opposite sector or side. This information implies at least one distance existing between centers of two barriers. This information may be useful to understand the annulus between the barriers and may be useful to understand materials and fillings to be applied to the annulus or conditions of such materials and fillings already applied to the annulus.

In at least one embodiment, a method and system herein include the use of first transducers and second transducers that are to be stationary with respect to circumferential positions of a pipe for measurements associated with the pipe eccentricity at individual depths in the downhole environment. For example, the reference to stationary is with respect to unintended movement. As the downhole tool herein has different transducers on different sectors, it is able to obtain information from all sides without having to rotate the downhole tool. Any incidental movement is understood to be within the scope of the stationary benefit of the first transducers and second transducers herein.

In at least one embodiment, another method and system include the use of first transducers that are capable of providing and receiving shear horizontal waves. For example, one transducer of the first transducers is in a transmitter mode to provide shear horizontal waves in a clockwise or counter-clockwise manner. The other transducers of the first transducers are in receiver modes to receive the shear horizontal waves that may induce TIEs and may include guided waves. Then the next transducer, in a sequential or non-sequential manner, may be in a transmitter mode with the other transducers of the first transducers are in a receiver mode. This process may be continued till all first transducers have functioned as transmitters at least once. Therefore, one or more of the first transducers are adapted to provide and receive shear horizontal waves.

In at least one embodiment, the method and system include the use of second transducers that are capable of providing and receiving Lamb waves, including flexural waves. For example, one transducer of the second transducers is in a transmitter mode to provide Lamb waves in a clockwise or counter-clockwise manner. The other transducers of the second transducers are in a receiver mode to receive the Lamb waves that may induce TIEs and may include guided waves. Then the next transducer, in a sequential or non-sequential manner, may be in a transmitter mode with the other transducers of the second transducers are in a receiver mode. This process may be continued till all second transducers have functioned as transmitters at least once. Therefore, one or more of the second transducers are adapted to provide and receive Lamb waves.

In at least one embodiment, the method and system includes a processor adapted to determine shear horizontal TIEs or Lamb TIEs from the shear horizontal waves or the Lamb waves received from the downhole environment. The system enables a method step for determining the pipe eccentricity based in part on the one or more of the shear horizontal TIEs or the Lamb TIEs. In at least one embodiment, further methods and systems herein include the use of one or more of the first and the second transducers to receive third-interface echoes (TIEs) that are shear horizontal TIEs or Lamb TIEs, from different circumferential locations of the downhole environment at the same time.

In at least one embodiment, methods and systems herein for a downhole tool can also address impropriety in tools having a requirement to at least transmit compressional waves into an axial orientation, and at an angle with respect to a longitudinal axis of a casing, pipe, or borehole, representing different vertical barriers and at a vertical height from a receiver. For example, such tools have angled transmitters to cause compression waves to hit internal surfaces of casings or the downhole environment in an angle sufficient to cause natural Lamb waves or natural shear horizontal waves. Such tools, therefore, do not include ability to transmit and receive shear horizontal signals/waves. As such, transmitters and receivers of such tools have vertical separation, which is a vertical distance that contributes to poor vertical resolution of the tool. Further, because of the vertical separation, the tool has its transmitter and receiver on different normal planes with respect to a longitudinal axis of a barrier.

In at least one embodiment, methods and systems herein for a downhole tool can additionally address impropriety in tools having a requirement to be spinning, with respect to circumferential positions of a pipe, for measurements associated with the pipe eccentricity at individual depths in the downhole environment. The spinning action allows use of a single transmitter-receiver pair and a pulse-echo receiver to receive TIE waves, but adds complexity to separate different measurements from different angles at the individual depths where such measurements associated with the pipe eccentricity are taken. Moreover, the TIE receiver in such system are receive third-interface echoes (TIEs) from different circumferential locations of the downhole environment at different times.

Further, when transmitters and receivers of a pitch-catch configuration are deployed in different normal planes (and having vertical separation), their measurements are unreliable for cement evaluation of wells due to limitations of tool principles, tool hardware, and/or data processing. The pulse-echo measurements provide acoustic impedance of casing loading. However, the pulse-echo measurement can lack information about bonding conditions of casing and cement, or cement and formation. Further, ultrasonic-based pitch-catch measurements can be utilized, based on attenuation analysis of guided waves, to detect bonding condition of cement. However, such a system may fail to differentiate between fast cement and fluids filled in annulus areas between casing and formation.

Extended data processing of ultrasonic pitch-catch measurements was developed to obtain TIEs. For example, leaked Lamb waves in a casing may propagate into material between an inner casing and a formation (or an external casing). The leaked Lamb waves of casing may be reflected by surfaces of all such formations (or external casing) that are barriers. These reflections can cause multiple TIEs. The TIEs can be identified from received Lamb waves, such as from the waveforms of the received Lamb waves.

In one example, transit times and amplitudes of the TIEs can be used to estimate acoustic impedance, velocity, or thickness of a material in the annulus between the different barriers. These estimated properties can be used to identify annular materials and/or geometry. Ultrasonic tools may have improprieties in its features and ability to receive waves propagating in liquid media in a pipe. For example, transducers of such ultrasonic tools may require liquid couplants. Further, received waveforms for such ultrasonic tools may be sensitive to mud attenuation. In a further example, a piezoelectric transducer used therein may be sensitive to the direction of wave propagation. Then, a TIE to be received in such ultrasonic tools may be missed in a well where any of the barriers are not parallel with respect to an axial of a casing, pipe, or borehole forming the barrier.

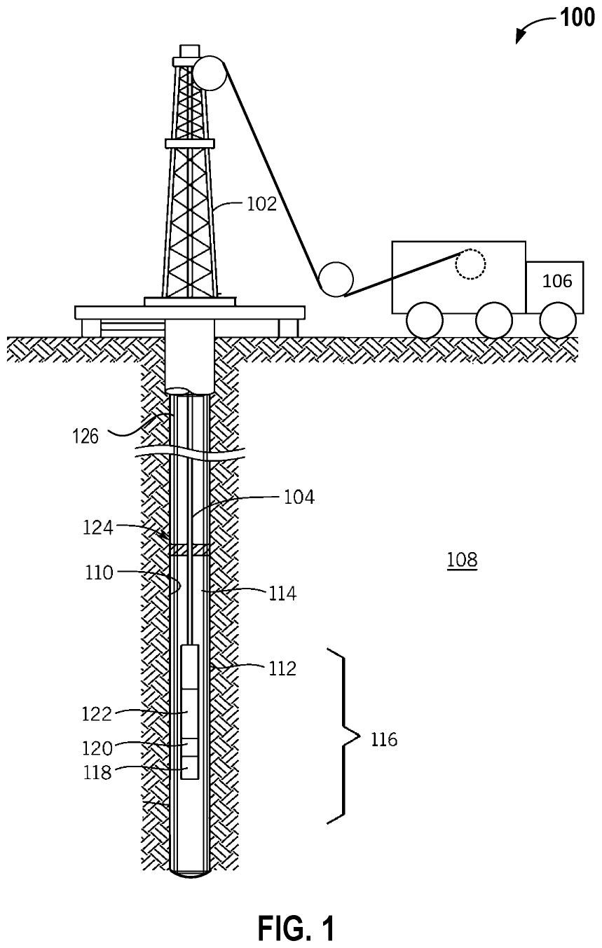

FIG. 1 illustrates an example environment 100 subject to determinations associated with pipe eccentricity in a downhole environment, in at least one embodiment herein. In FIG. 1, the environment 100 includes a rig 102 and a supporting vehicle 106 to include at least part of a system of the disclosure herein and to support the method of the disclosure herein. However, other configurations such surface equipment may be used to support the method and system herein.

A downhole environment 108 is illustrated as associated with a wellbore 124 for plugged and abandoned (P&A) well-operation or is part of a drilling operation that was previously performed. The downhole environment 108 may include barriers 126 having annular spaces (or annulus) with an applied filling, such as water and cement, and/or with natural filling, such as oil, water, and gas. For P&A well-operations, the cement may be used to seal an annulus. In one example, an annulus that is a space between the wellbore 124 and casings (including their collars) of the barriers 126 that may be filled with cement for sealing purposes.

Further, several casing of the barriers 124 may be coupled together using collars to stabilize features of the wellbore 124. The casings may be pipes of different or same length that are provided together to reach the depths in the downhole environment 108. The surface equipment 102, 104 may be used for well-logging operations. These operations may include detecting and monitoring conditions of the wellbore 124. The operations may include measuring of parameters of downhole environment 108 and/or, specifically, of the wellbore 124. The parameters may be related to cement bonding and other evaluation used to ensure a soundness of the cement filling and the isolation offered by such cement filling in the wellbore 124. In at least one embodiment, to perform such soundness evaluation, one or more acoustic logging tools 118-122 maybe part of a downhole tool 116 deployed via a cable 104. In at least one embodiment, the downhole tool 116 is provided at the center 114 of the barriers 126 made of at least one exterior casing 110 that interfaces with a surface of the downhole environment 108.

In at least one embodiment, the acoustic logging tools 118-122 may be lowered by a cable 104 using spools of a supporting vehicle 106. The cable 104 may be a mechanical cable. However, an electrical or an electro-optical cable may be also used. The electro-optical cable may include fiber optics and may be protected against the downhole environment 108. In at least one embodiment, the downhole tool 116 may be lowered using coiled tubing.

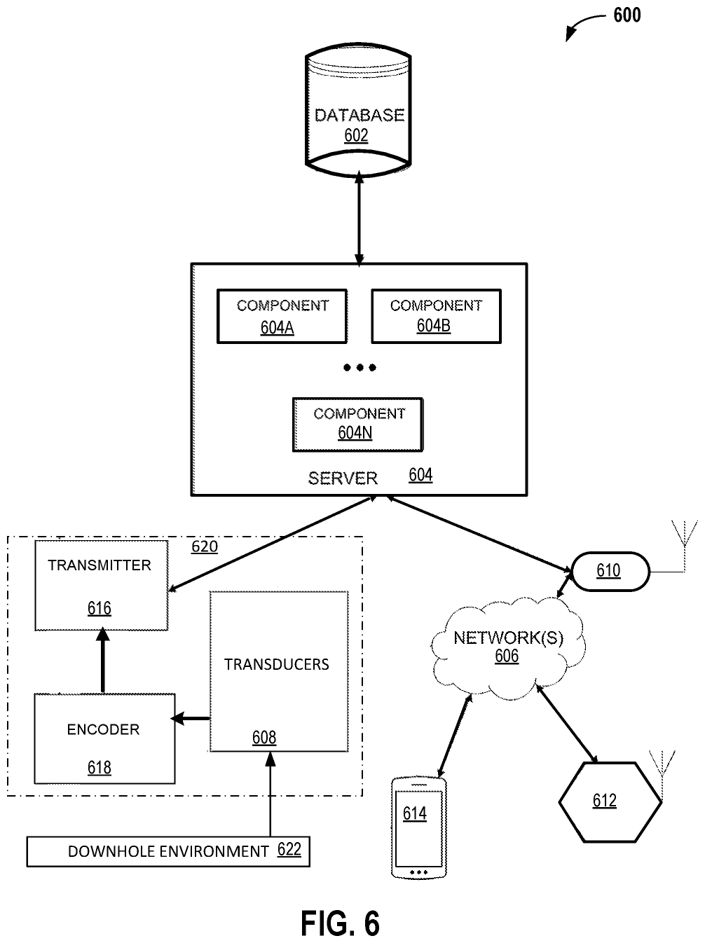

In at least one embodiment, the one or more acoustic logging tools 118-122 at least includes at least part of a system herein for determinations associated with pipe eccentricity in a downhole environment. In at least one embodiment, the downhole tool 116 transmits data to the surface to be processed in the vehicle 106 or in a remote location than the location of wellbore 126. Further, the downhole tool 116 may store or process in part the data received. Aspects of such storing and processing features in such a system in FIG. 1 is detailed in FIG. 6.

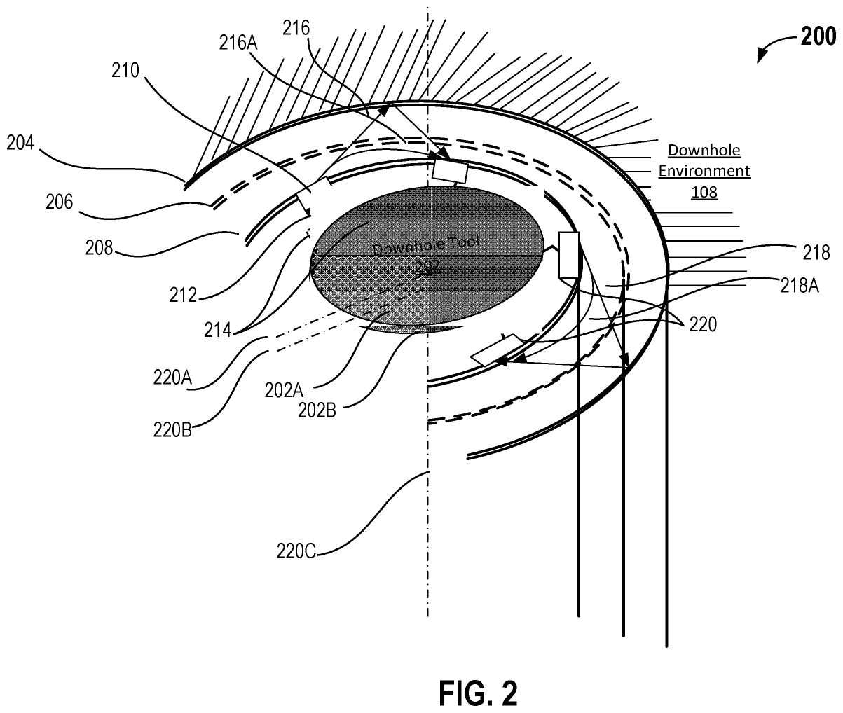

FIG. 2 illustrates a section 200 of system for determinations associated with pipe eccentricity in a downhole environment of at least one embodiment herein. The section 200 illustrated in FIG. 2 includes at least a downhole tool 202 having a first pad 202A and a second pad 202B with a separation therebetween. Such separation may be a 1 foot separation. The first pad 202A may include six first transducers 210 that are capable of providing and receiving shear horizontal waves. A second pad 202B may include six second transducers 220 that are capable of providing and receiving Lamb waves.

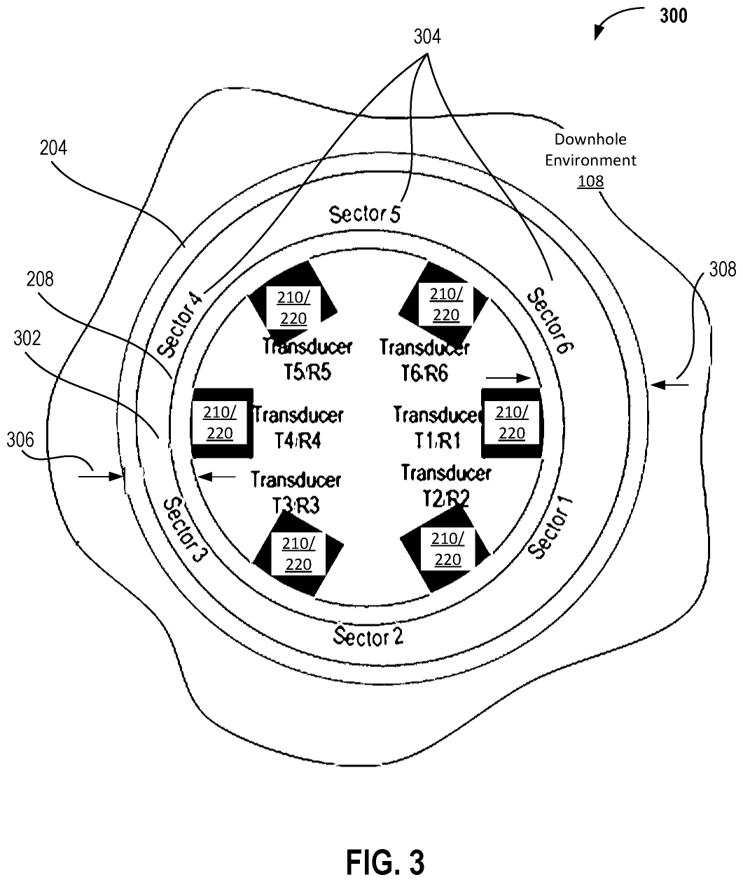

The first and the second transducers 210, 220 are in a pitch-catch configuration and may each be electromagnetic acoustic transducers (EMAT) transducers, as described further with respect to FIG. 3. The first and the second transducers 210, 220, in each of multiple sectors (such as sectors 304 in FIG. 3) of the downhole tool 202 and the downhole environment 108 allow for measurements from different circumferential positions in the downhole environment 108 at the same time. There may be six sectors, as illustrated in FIG. 3, each with its own first transducer and with own second transducer. Therefore, of the twelve transducers, only two of each are illustrated.

Once the downhole tool 202 is at a depth, with respect to a vertical axis 220A, then fingers 212 extend to push out the different transducers 210, 220 from their contracted positions 214, in each pad 202A, 202B, to positions that are against (either touching an or a having a gap with respect to) an inner casing surface of an inner casing 208. Once against the inner surface of the inner casing 208, the first and second transducers 210, 220 may perform measurements described throughout herein.

The TIE described herein is with respect to either of the inner surface of the exterior casing 206 or the inner surface of the further barrier 204, which are each a third interface but are not together a third interface. Particularly, the TIE only exists for one third interface. Therefore, an inner surface and an outer surface of the inner casing 208 form the first two interferences, and the TIE is from the third interface. After a third interface, the echoes may not be significant to measure. Therefore, there may be an exterior casing 206 to provide the TIEs or the inner surface of the further barrier 204 (such as a cement layer of a formation) that is generally represented (and discussed) together with the downhole environment 108 provide the TIEs.

In at least one embodiment, the system in the section 200 of FIG. 2 includes a downhole tool 202 having first (EMAT) transducers and second (EMAT) transducers with different measurement features—such as for shear horizontal waves and for Lamb waves. These transducers 210, 220 are on separate normal planes 220A, B with respect to a longitudinal axis 220C of a barrier, such as an inner casing 208 in the downhole environment 108. The first transducers 210 are adapted to provide and receive a shear horizontal signal/wave 216 at different times (functioning in a transmitter mode or a receiver mode at different times). The second transducers 220 are adapted to provide and receive a Lamb signal/wave 218 at different times (functioning in a transmitter mode or a receiver mode at different times). The transmitter mode in each transducer can support a generation feature for the respective wave/signal, as well. The shear horizontal signal/wave 216 and the Lamb signal/wave 218 are for at least one casing 206 in the downhole environment 108.

The shear horizontal signal/wave 216 and the Lamb signal/wave 218 that are received in a respective transducer in a receiver mode may be reflected from the casing 206 or the formation 204. Further, the shear horizontal signal/wave 216 and the Lamb signal/wave 218 may included guided waves 216A, 218A that are not reflected but are from a transducer in a transmitter mode to a transducer in a receiver mode. The guided waves 216A, 218A are received first in a time window versus the reflected waves. A processor may be used to perform extraction of the TIEs from the reflected waves, for instance.

Further, FIG. 2 also illustrates that system herein supports a method step for determining the pipe eccentricity, using third-interface echoes (TIEs) from the second transducers, at depths that are unrestricted by locations of at least the first transducers on the downhole tool 202. For example, because the shear horizontal wave transducers 210 are all on a same normal plane 220A with respect to a longitudinal axis 220C of a barrier, there are no restrictions to the depths at which measurements may be taken. This is similarly the case for Lamb wave transducers 220 that are all on a same normal plane 220B with respect to the longitudinal axis 220C of the barrier. There is improved vertical resolution as a result.

Still further, FIG. 2 also illustrates that the first transducers and the second transducers are to be stationary with respect to circumferential positions of a pipe, such as an inner casing 208, for measurements associated with the pipe eccentricity at individual depths in the downhole environment 108. As there are multiple transducers 210, 220, and at least one for each sector 304 (in FIG. 3), there is no need to rotate the downhole tool 202 to ensure complete coverage (such as 360 degree coverage) of the annulus and the barriers. Any movement otherwise is incidental and not intended for the measurements.

In addition, FIG. 2 illustrates that the second transducers are adapted to receive reflected waves having third-interface echoes (TIEs) from different circumferential locations of the downhole environment at the same time. As there are multiple transducers 210, 220, and at least one for each sector 304 (in FIG. 3), the data obtained occurs at the same time for at least one shear horizontal wave transducer 210 and one Lamb wave transducer 220 when each of the multiple pads 202A, B may be activated at the same time without rotating a tool. This causes collection of reflected and guided waves in each pad 202A, B for at least one sector at the same time.

In at least one embodiment, this arrangement for a downhole tool 202 is therefore beneficial for not requiring specific angles and vertical separations, as against a compressional wave transducer to cause generation of Lamb waves, for instance. Instead, each of the multiple transducers 210, 220 herein is adapted to transmit and to receive a shear horizontal wave or a Lamb wave for at least one casing or the formation of the downhole environment.

FIG. 3 illustrates further aspects of a system 300 for determinations associated with pipe eccentricity in a downhole environment of at least one embodiment herein. FIG. 3 is a plan view of one pad 202A/B of transducers 210/220 of a downhole tool 202. The plan view illustrates that division of the transducers 210/220 in each pad 202A/B by six sectors. FIG. 3 illustrates that it is possible to determine the thicknesses 306, 308 of different parts of an annulus 302 to then determine pipe eccentricity of an inner casing 208 against an outer casing or a formation 204.

In at least one embodiment, the transducers 210/220 are electromagnetic acoustic transducers (EMATs) transducers that are used to collect waves that are either reflected or guided. At least the reflected waves may include TIEs (as signals having information therein). Therefore, the transducers 210, 220 in FIG. 2 use EMATs to excite and measure shear horizontal waves or Lamb waves that propagate circumferentially within a casing 208. The EMAT transducers 210, 220 may not require contact or coupling to the inner surface of the casing 208. Further, the EMAT transducers 210, 220 are not sensitive to a condition of the inner surface of the casing 208 or to the wave propagation angle. Further, the EMAT transducers 210, 220 are supported by their associated shear horizontal and Lamb transmitters and receivers in pitch-catch configurations, as illustrated in FIG. 2.

Additionally, a vertical resolution of the Lamb wave measurements may be controlled by vertical sampling rate of the tool and not by the vertical separation of the pitch-catch configuration of the transmitter-receiver. Further, the EMAT transducers 210, 220 provide fully compensated measurements. For example, the EMAT transducers 210, 220 can be used to improve an accuracy of estimated transit times of TIEs. In a further example, a compensated waveform measurement from Sector 1 of the sectors 304 can be obtained by averaging clockwise T1R2 and counterclockwise T2R1. In FIG. 3, T denotes the use of an EMAT transducer 210, 220 as a transmitter, while R denotes the use of an EMAT transducer 210, 220 as a receiver. Similarly, a compensated attenuation measurement from Sector 1 of the sectors 304 can be obtained by averaging clockwise T6Δ(R1R2) and counterclockwise T3Δ(R2R1), where Δ denotes attenuation measurement between two receivers.

In at least one embodiment, while Lamb waves are excited and received by an EMAT transducer 210; 220, a guided wave of the inner casing 208 may have wave packets of both short-path and long path as they propagate circumferentially. Both, an extensional (S0) mode and flexural mode (AO) can, therefore, coexist in the Lamb waves. With the annulus 302 between an internal casing 208 and a formation 204 (or external casing 206) filled with water, there may be multiple strong TIEs generated. The multiple TIEs may be difficult to separate if an inner casing 208 is too close to the formation 204 (or external casing 206). Therefore, approaches herein include algorithmic compensation to pick up TIEs automatically and reliably. This is so that the properties of material filled in the annulus 302 between internal casing 208 and formation 204 (or external casing 206) can be estimated reliably to enhance the cement evaluation of the wellbore 126.

Further, to reliably identify positions and amplitudes of TIE for accurately estimating a velocity of filled-in material or thickness of annulus 302, a time-frequency analysis technique may be performed. This time-frequency analysis technique may be based on continuous wavelet transform of a Lamb waveform. For example, as to the algorithmic compensation, log data for Lamb waves can be transformed into a time-frequency domain using continuous wavelet transform (CWT) and a scale associated therewith can be converted to frequency. A power scalegram may be computed based on an amplitude scalegram. The power scalegram may be truncated to remove its noise. The truncated power scalegram can then be projected to a time axis. Peaks of a squared root of the projected power scalegram can be picked up to label the TIE.

A pipe eccentricity of the inner casing 208, relative to formation 204 (or external casing 206) may be determined from transit times T_{t,i} of TIE for Lamb waves received by azimuthally located EMAT transducers 210, 220. In the transit times, i is a sequential number of the EMAT transducers 210, 220. Then, T_{t,i} of TIE can be determined from arrival times t_{g,i} and t_{TIE,i} of a guided wave echo and its nearest TIE by Equation (1):

T_{t,i}=t_{TIE,i}−t_{g,i}, where i=1,2, . . . ,6 Equation (1)

Further, T_{t,i} of TIE can be determined from arrival times t_{TIE1,i} and t_{TIE2,i} of two neighboring TIEs, by Equation (2):

T_{t,i}=t_{TIE2,i}−t_{TIE1,i}, where i=1,2, . . . ,6 Equation(2)

The eccentricity of the inner casing may be determined using Equation (3):

$${ε}_{i} = \frac{{T}_{t , i} - {T}_{t , c}}{{T}_{t , c}} , where i = 1 , 2 , ... , 6 \qquad Equation ( 3 )$$

In Equation (3), T_{t,c} is given by Equation (4):

T_{t,c}=1/6Σⱼ₌₁⁶T_{t,j} Equation(4).

In at least one embodiment, a velocity of the material filled in the annulus 302 between barriers 126; 208, 206, 204, or different thicknesses 306, 307 of the annulus 302 (to support eccentricity of one barrier against another) can be estimated from the transit time of TIE. For example, when the velocity of the material filled into the annulus 302 is known, the thickness of the annulus 302 can be determined using Equation (5) or (6):

$${T}_{h} = \frac{1}{2} \frac{{v}_{m} ( {t}_{TIE , i} - {t}_{g , i} )}{1 - sin θ} \qquad Equation ( 5 )$$

$${T}_{h} = \frac{1}{2} \frac{{v}_{m} ( {t}_{TIE 2 , i} - {t}_{TIE 1 , i} )}{cos θ} \qquad Equation ( 6 )$$

In these Equations, θ is a beam angle of the TIE. When an outer diameter (OD) of an inner casing 208 and an inner diameter (ID) of a formation/wellbore 204 (or an ID of an external casing 206) are known, a gap between inner casing 208 and formation/wellbore 204 (or an external casing 206) can be determined by Equation (7), (8), (9), or (10):

$${v}_{m} = ( 1 - sin θ ) ( 1 - {ε}_{i} ) \frac{{OD}_{casing 1} - {ID}_{formation / wellbore}}{{t}_{TIE , i} - {t}_{g , i}} \qquad Equation ( 7 )$$

$${v}_{m} = ( 1 - sin θ ) ( 1 - {ε}_{i} ) \frac{{OD}_{casing 1} - {ID}_{casing 2}}{{t}_{TIE , i} - {t}_{g , i}} \qquad Equation ( 8 )$$

$${v}_{m} = ( 1 - {ε}_{i} ) \frac{{OD}_{casing 1} - {ID}_{wellbore}}{{t}_{TIE 2 , i} - {t}_{TIE 1 , i}} cos θ \qquad Equation ( 9 )$$

$${v}_{m} = ( 1 - {ε}_{i} ) \frac{{OD}_{casing 1} - {ID}_{casing 2}}{{t}_{TIE 2 , i} - {t}_{TIE 1 , i}} cos θ \qquad Equation ( 10 )$$

In at least one embodiment, as a result, a downhole tool 202 using features in FIG. 3 for measurements associated with pipe eccentricity does not require consideration to a liquid-filled inner casing for acoustic coupling. The arrangement of the transducers 210, 220 in the downhole tool 202 can enable fully-compensated measurements. This approaches herein enable capture of TIE, even when a wall of an inner casing 208 is not parallel to a formation/wellbore 204 (or an external casing 206). Furthermore, a vertical resolution of respective pipe eccentricity may be determined by a vertical sampling rate of the downhole tool 202, instead of a vertical separation of the transmitter-receiver that offers poor vertical resolution. Additionally, a long length of received waveforms can provide a time window to exposure of trainsets of TIE for determining the types of filled-in materials in an annulus 302 and for determining acoustic impedance contrast of filled materials and well barriers.

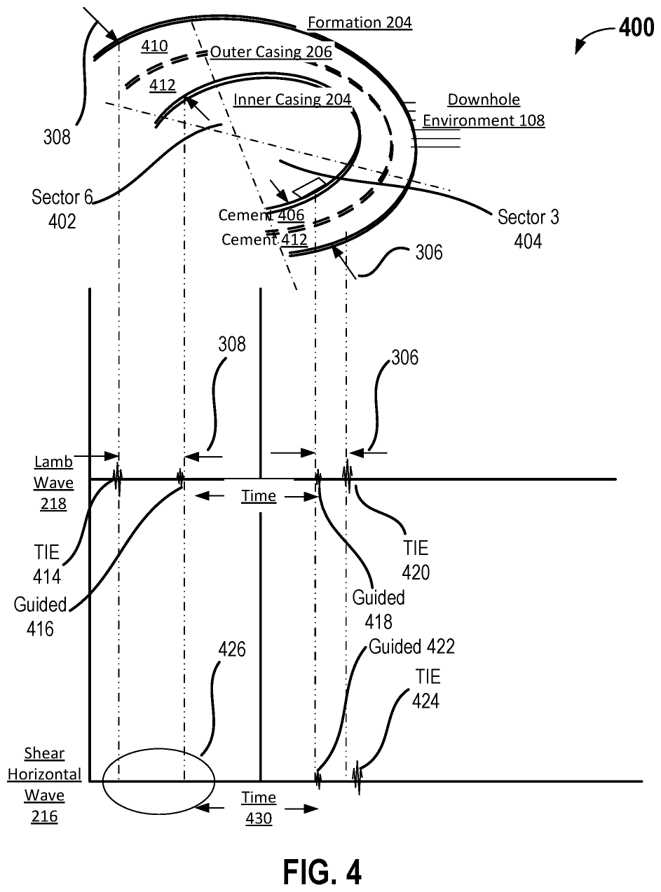

FIG. 4 illustrates waveform features 400 of a method for determinations associated with pipe eccentricity in a downhole environment of at least one embodiment herein. In at least one embodiment, shear horizontal waves 216 are received differently than Lamb waves 218. They may be plotted and analyzed distinctly. Initially, the waveform features 414-424 are illustrative of actual waveforms, but are not the actual waveforms and are not to scale.

FIG. 4 illustrates that Lamb waves 218 can transmit through liquid in an annulus 302, but not through gas in the same or a different annulus. As a result, Lamb TIE waveforms 414, 416 may be determined from reflected Lamb waves for the barrier (formation) 204 assuming that an outer casing 206 is not present. However, in the presence of an outer casing 206 would cause TIE to be provided from this barrier. Furthermore, the absence of a Lamb TIE may indicate gas between the inner casing 208 and the outer casing 206 or formation 204.

Similarly, the absence of a shear horizontal TIE may indicate presence of a liquid as the shear waves may not transmit through liquid. This is in situations where an annulus 410, 412 has irregular fillings and allow (or have) gases and liquids therein. Furthermore, Lamb waves 248 also transmit through solids and particulate material, such as different fill-velocity cements 406, 412 in the annulus 410, 412. As a result, Lamb TIEs or waveforms 414, 420 and shear horizontal TIEs or waveforms 424 can also detected for such materials.

FIG. 4 illustrates further that guided waveforms 416, 418, 422 that are either Lamb or shear horizontal are received first, with respect to time 430, for receivers that are shear horizontal or Lamb at the depth where measurements are occurring. Further, the Lamb waves are received ahead of the shear horizontal waveforms, in time 430. The time 430 scale is from a 0 time unit to forward time units in each direction and provided as illustrated to indicate the significance of the waveforms respective to each other and to relative time values.

Further, the guided waveforms 416, 418, 422 are merely a receipt of Lamb or shear horizontal waves that are not bounced against any barriers 126 and that are received earliest in a time window. Further, in FIG. 4, first Lamb TIE waveforms 414 and second Lamb TIE waveforms 420 may be received in opposing sectors (sector 3 404 and sector 6 402) at different times. Then, distances 306, 308 within the Lamb TIE waveforms 414, 420 correspond to physical eccentricities of the first barrier (inner casing 208) to the barrier (that is either formation 204, as illustrated, or an outer casing 206 and not the formation 204, if the outer casing 206 is provided). The distances 306, 308 also corresponds to thicknesses 306, 308 of the annulus 302. Similarly, subsequent Lamb TIE waveforms can correspond to further distances around the casing 208 till a 360 degree coverage is obtained. Then, such collection of distances may be used to determine pipe eccentricities of at least one barrier with respect to another barrier.

In at least one embodiment, shear horizontal wave forms cannot travel through liquids and are therefore absent 426 in some parts of the analysis of the waveforms in FIG. 4, which is only for illustrative purposes. There may be no shear horizontal TIE waveforms with respect to the sector 6 402 at that depth where measurements are occurring. However, for sector 3 404, there are shear horizontal guided waveforms 422 received, followed by shear horizontal TIE waveforms 424 from the first subsequent barrier that is either formation 204, as illustrated, or an outer casing 206 and not the formation 204, if the outer casing 206 is provided. The use of the shear horizontal and Lamb transducers in their respective normal (horizontal) plane is apparent by the benefits of being able to analyze pipe eccentricities through at least one barrier and through different fillings in different parts of the annulus 302 caused by at least two barriers.

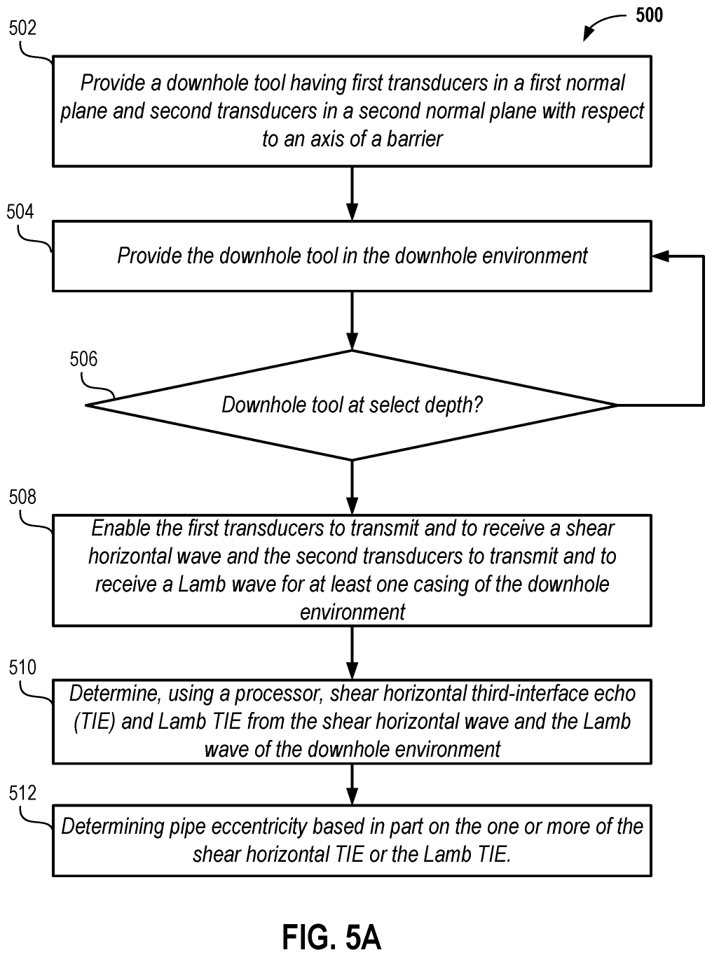

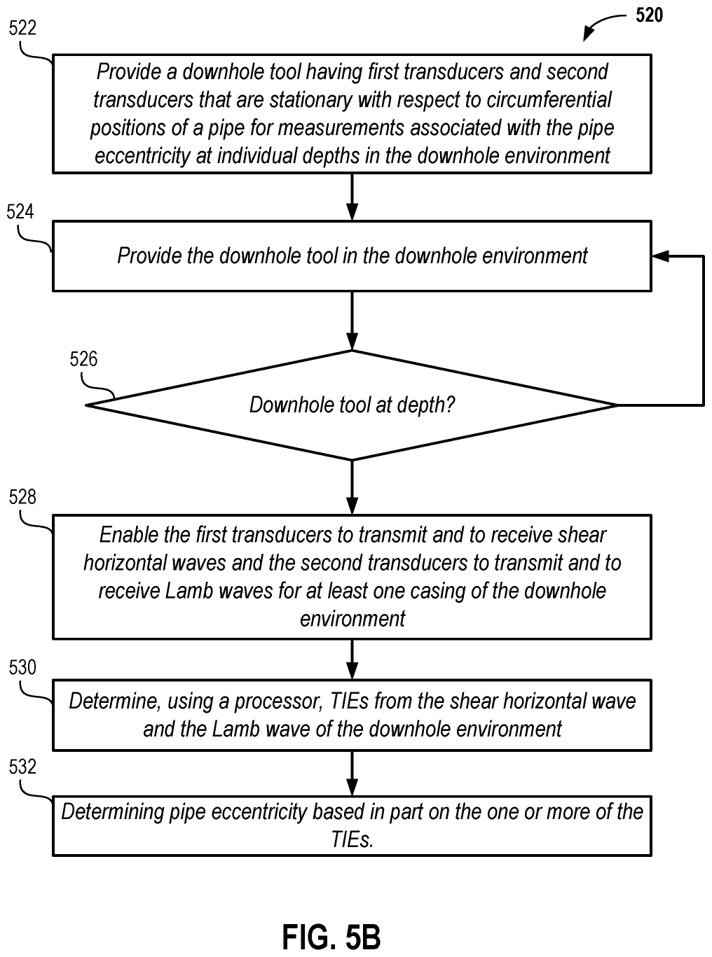

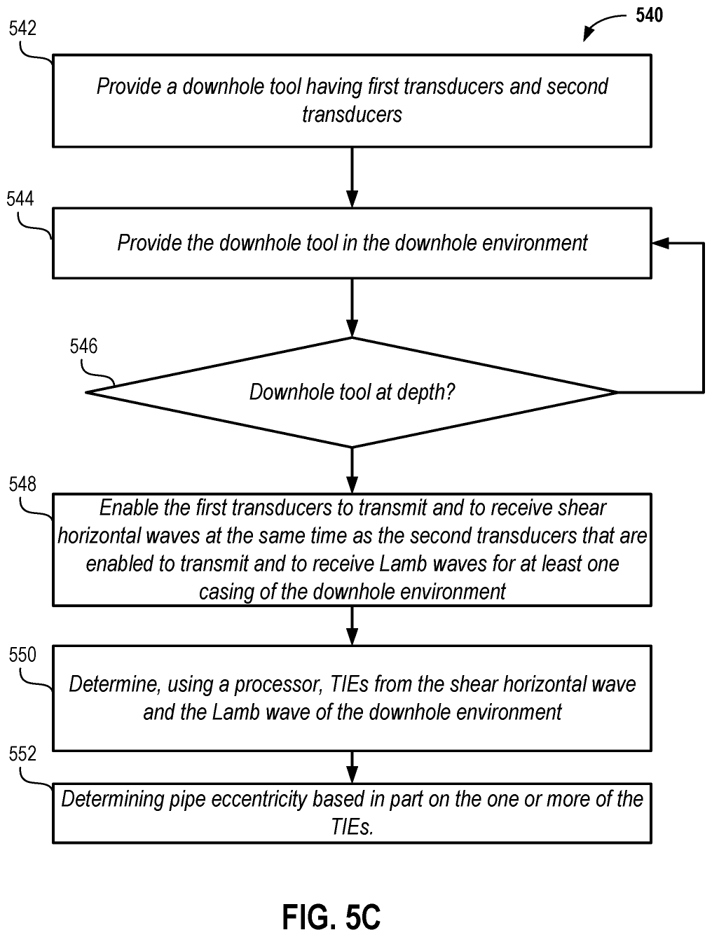

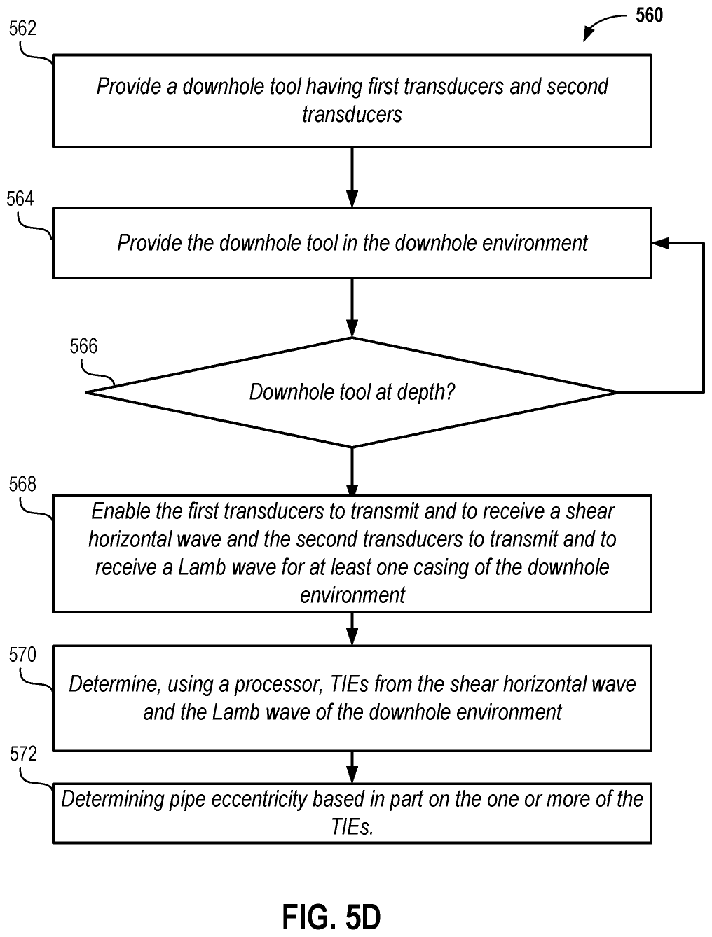

FIGS. 5A-D illustrate methods 500-560 for determinations associated with pipe eccentricity in a downhole environment, in different embodiments. In at least one embodiment, FIG. 5A is a method 500 for determinations associated with pipe eccentricity in a downhole environment may be supported by the systems described in FIGS. 1-4. The method 500 includes providing (502) a downhole tool having first transducers in a first normal plane and second transducers in a second normal plane, both normal planes being normal with respect to a longitudinal axis of a barrier. The method includes providing (504) the downhole tool into the downhole environment. A verification (506) may be performed that a select or intended depth is reached for measurements to occur.

The method 500 includes enabling (508) the first transducers to transmit and to receive shear horizontal waves and the second transducers to transmit and to receive Lamb waves for at least one casing in the downhole environment. For example, first shear horizontal waves are provided and second shear horizontal waves, which are associated with the first shear horizontal waves (such as, by reflection of the first shear horizontal waves, from a casing or a formation), are received. Similarly, first Lamb waves are provided and second Lamb waves, which are associated with the first Lamb waves (such as, by reflection of the first Lamb waves, from a casing or a formation), are received. The method 500 includes determining (510), using a processor, shear horizontal third-interface echoes (TIEs) and Lamb TIEs from the shear horizontal waves and from the Lamb waves that are received in the downhole environment. As described throughout herein, such second shear horizontal waves and Lamb waves may be reflected in the downhole environment. The method 500 includes determining (512) pipe eccentricity for at least one barrier based in part on the one or more of the shear horizontal TIEs or the Lamb TIEs.

In at least one embodiment, FIG. 5B is a method 520 for determinations associated with pipe eccentricity in a downhole environment may be supported by the systems described in FIGS. 1-4. The method 520 includes providing (522) a downhole tool having first transducers and second transducers that are to be stationary with respect to circumferential positions of a pipe for measurements associated with the pipe eccentricity at individual depths in the downhole environment. Further, there is no requirement for different normal planes in at least one embodiment and the first and second transducers may be on the same normal plane. The method 520 includes providing (524) the downhole tool into the downhole environment. The method 520 includes a verification (526) that may be performed that a select or intended depth is reached for measurements to occur.

The method 520 includes enabling (528) the first transducers to transmit and to receive shear horizontal waves and the second transducers to transmit and to receive Lamb waves for at least one casing in the downhole environment. As explained with respect to FIG. 5A, first shear horizontal waves are provided and second shear horizontal waves, which are associated with the first shear horizontal waves (such as, by reflection of the first shear horizontal waves, from a casing or a formation), are received. Similarly, first Lamb waves are provided and second Lamb waves, which are associated with the first Lamb waves (such as, by reflection of the first Lamb waves, from a casing or a formation), are received. The method 520 includes determining (530), using a processor, TIEs from the shear horizontal waves and from the Lamb waves received in the downhole environment. As described throughout herein, such second shear horizontal waves and Lamb waves may be reflected in the downhole environment. The method 520 includes determining (532) pipe eccentricity using one or more of the TIEs.

In at least one embodiment, FIG. 5C is a method 540 for determinations associated with pipe eccentricity in a downhole environment may be supported by the systems described in FIGS. 1-4. The method 540 includes providing (542) a downhole tool having first transducers and second transducers. The method 540 includes providing (544) the downhole tool into the downhole environment. A verification (546) may be performed that a select or intended depth is reached for measurements to occur.

The method 540 includes enabling (548) the first transducers to transmit and to receive shear horizontal waves at a same time as the second transducers that are enabled to transmit and to receive Lamb waves for at least one casing in the downhole environment. As in FIGS. 5A and 5B, first shear horizontal waves are provided and second shear horizontal waves, which are associated with the first shear horizontal waves (such as, by reflection of the first shear horizontal waves, from a casing or a formation), are received. Similarly, first Lamb waves are provided and second Lamb waves, which are associated with the first Lamb waves (such as, by reflection of the first Lamb waves, from a casing or a formation), are received. The method 540 includes determining (550), using a processor, TIEs from the shear horizontal waves and from the Lamb waves received in the downhole environment. As described throughout herein, such second shear horizontal waves and Lamb waves may be reflected in the downhole environment. The method 540 includes determining (552) pipe eccentricity using one or more of the TIEs.

In at least one embodiment, FIG. 5D is a method 560 for determinations associated with pipe eccentricity in a downhole environment may be supported by the systems described in FIGS. 1-4. The method 560 includes providing (562) a downhole tool having first transducers and second transducers. The method 560 includes providing (564) the downhole tool into the downhole environment. A verification (566) may be performed that a select or intended depth is reached for measurements to occur.

The method 560 includes enabling (568) the first transducers to transmit and to receive shear horizontal waves and the second transducers to transmit and to receive Lamb waves for at least one casing in the downhole environment. As in FIGS. 5A and 5B, first shear horizontal waves are provided and second shear horizontal waves, which are associated with the first shear horizontal waves (such as, by reflection of the first shear horizontal waves, from a casing or a formation), are received. Similarly, first Lamb waves are provided and second Lamb waves, which are associated with the first Lamb waves (such as, by reflection of the first Lamb waves, from a casing or a formation), are received. The method 540 includes determining (570), using a processor, TIEs from the shear horizontal waves and from the Lamb waves in the downhole environment. As described throughout herein, such second shear horizontal waves and Lamb waves may be reflected in the downhole environment. The method 570 includes determining (572) pipe eccentricity using one or more of the TIEs.

FIG. 6 illustrates a system 600 for determinations associated with pipe eccentricity in a downhole environment, according to at least one embodiment. The system 600 may include computer and network aspects. In at least one embodiment, these computer and network aspects 600 may include a distributed system. In at least one embodiment, a distributed system 600 may include one or more computing devices 612, 614. In at least one embodiment, one or more computing devices 612, 614 may be adapted to execute and function with a client application, such as with browsers or a stand-alone application, and are adapted to execute and function over one or more network(s) 606, which may include downhole inter-tool communications and telemetry to surface (such as using mudpule and electromagnetic telemetry), with a receiver on a surface being capable of telemetry acquisition.

In at least one embodiment, a server 604, having components 604A-N may be communicatively coupled with computing devices 612, 614 via network 606 and via a receiver device 608, if provided. In at least one embodiment, components 612, 614 include processors, memory, and random-access memory (RAM). In at least one embodiment, server 604 may be adapted to operate services or applications to manage functions and sessions associated with database access 602 and associated with computing devices 612, 614. In at least one embodiment, a server 604 may be associated with transducers 608 of a downhole tool 620, where such a transducers may include shear horizontal pitch-catch transducer and Lamb pitch-catch transducers. In at least one embodiment, an encoder 618 may be associated with the downhole tool 620.

In at least one embodiment, a transmitter 616 may be associated with the encoder 618. In at least one embodiment, an encoder 618 and a transmitter 616 may include a processor and memory having instructions that when executed by the processor can cause the encoder and transmitter 616 to perform encoding functions for determinations associated with pipe eccentricity in a downhole environment, throughout herein and at least in reference to FIGS. 3, 4A, and 5.

In at least one embodiment, a server 604 may be at a wellsite location, but may also be at a distinct location from a wellsite location to perform determinations associated with pipe eccentricity in a downhole environment. In at least one embodiment, such a server 604 may support a downhole tool 620 for data handling in downhole operations in a downhole environment 622. Such a tool 620 may operate partly downhole and partly at a surface environment. Such a tool 620 may include subsystems to perform functions described throughout herein.

The subsystems may be modules that may be able to test or train a system on a surface level using the determinations associated with pipe eccentricity in a downhole environment. The subsystem may be encased in one or more computing devices having at least one processor and memory so that the at least one processor can perform functions based in part on instructions from the memory executing in the at least one processor. In at least one embodiment, even though illustrated together, the system boundary 618 may be part of the transducers 608, an encoder 618 and a transmitter 616. In at least one embodiment, the server 604 and computing devices 610-614 may be in different geographic locations, including downhole and surface areas.

Therefore, in at least one embodiment, a system herein includes one or more processors (such as being any of one or more component 604A-N) of a server 604 or that may be elsewhere in the system 600. The one or more processors are to determine a pipe eccentricity of a casing in a downhole environment based in part on the one or more of shear horizontal third-interface echoes (TIEs) or Lamb TIEs. The shear horizontal TIEs or the Lamb TIEs is determined from received shear horizontal waves or received Lamb waves. The received shear horizontal waves is from one or more first transducers and the received Lamb waves is from the one or more second transducers, together illustrated as a set of transducers 608 of a downhole tool 620. The one or more first transducers are to provide shear horizontal waves from a downhole tool into the casing of the downhole environment and to cause the received shear horizontal waves. Further, the one or more second transducers are to provide Lamb waves from the downhole tool into the casing and to cause the received Lamb waves.

The transducers 608 of a downhole tool 620 is provided to perform measurements described throughout herein for a downhole environment 622. In at least one embodiment, a system for determinations associated with pipe eccentricity in a downhole environment may be adapted to transmit, either through wires or wireless, information received therein, from a downhole environment to a surface environment. In at least one embodiment, modeling in an encoder 618 and a transmitter 616 can be performed using machine learning and artificial intelligence (AI/ML) taking the shear horizontal TIE waveform and/or the Lamb TIE waveform as input, along with time information associated with such waveforms, to infer the barriers and to infer eccentricities of the one or more barriers.

The encoder and transmitter 616-618 can communicate with transducers 618, which communicate with barriers of a downhole environment 622. In at least one embodiment, determinations associated with pipe eccentricity in a downhole environment may require specific input from a server 604 to be used to fit input received from the waveforms with inferences allowed to be made by the AI/ML algorithm. In at least one embodiment, trained ML/AI algorithms may be used with each inference of the barrier eccentricity or conditions behind a barrier, and with waveform data to classify the waveform data to the inferences. In at least one embodiment, a least error may reinforce the use of the same inferences for future waveform data.

In at least one embodiment, one or more component 604A-N may be adapted to function as a signal provisioning or detector device within a server 604. In at least one embodiment, one or more components 604A-N may include one or more processors and one or more memory devices adapted to function as a detector or receiver device, while other processors and memory devices in server 604 may perform other functions.

In at least one embodiment, a server 604 may also provide services or applications that are software-based in a virtual or a physical environment (such as to support the simulations referenced herein). In at least one embodiment, when server 604 is a virtual environment, then components 604A-N are software components that may be implemented on a cloud. In at least one embodiment, this feature allows remote operation of a system for determinations associated with pipe eccentricity in a downhole environment, as discussed at least in reference to FIGS. 1-5E. In at least one embodiment, this feature also allows for remote access to information received and communicated between any of aforementioned devices. In at least one embodiment, one or more components 604A-N of a server 604 may be implemented in hardware or firmware, other than a software implementation described throughout herein. In at least one embodiment, combinations thereof may also be used.

In at least one embodiment, one computing device 610-614 may be a smart monitor or a display having at least a microcontroller and memory having instructions to enable display of information monitored by a detector. In at least one embodiment, one computing device 610 may be a transmitter device to transmit directly to a receiver device or to transmit via a network 606 to a receiver device that may be part of an encoder and transmitter 616 and to transmit to a server 604, as well as to other computing devices 612, 614.

In at least one embodiment, other computing devices 612, 614 may include portable handheld devices that are not limited to smartphones, cellular telephones, tablet computers, personal digital assistants (PDAs), and wearable devices (head mounted displays, watches, etc.). In at least one embodiment, other computing devices 612, 614 may operate one or more operating systems including Microsoft Windows Mobile®, Windows® (of any generation), and/or a variety of mobile operating systems such as iOS®, Windows Phone®, Android®, BlackBerry®, Palm OS®, and/or variations thereof.

In at least one embodiment, other computing devices 612, 614 may support applications designed as internet-related applications, electronic mail (email), short or multimedia message service (SMS or MMS) applications and may use other communication protocols. In at least one embodiment, other computing devices 612, 614 may also include general purpose personal computers and/or laptop computers running such operating systems as Microsoft Windows®, Apple Macintosh®, and/or Linux®. In at least one embodiment, other computing devices 612, 614 may be workstations running UNIX® or UNIX-like operating systems or other GNU/Linux operating systems, such as Google Chrome OS®. In at least one embodiment, thin-client devices, including gaming systems (Microsoft Xbox®) may be used as other computing device 612, 614.

In at least one embodiment, network(s) 606 may be any type of network that can support data communications using various protocols, including TCP/IP (transmission control protocol/Internet protocol), SNA (systems network architecture), IPX (Internet packet exchange), AppleTalk®, and/or variations thereof. In at least one embodiment, network(s) 606 may be a networks that is based on Ethernet, Token-Ring, a wide-area network, Internet, a virtual network, a virtual private network (VPN), a local area network (LAN), an intranet, an extranet, a public switched telephone network (PSTN), an infra-red network, a wireless network (such as that operating with guidelines from an institution like the Institute of Electrical and Electronics (IEEE) 802.11 suite of protocols, Bluetooth®, and/or any other wireless protocol), and/or any combination of these and/or other networks.

In at least one embodiment, a server 604 runs a suitable operating system, including any of operating systems described throughout herein. In at least one embodiment, server 604 may also run some server applications, including HTTP (hypertext transport protocol) servers, FTP (file transfer protocol) servers, CGI (common gateway interface) servers, JAVA® servers, database servers, and/or variations thereof. In at least one embodiment, a database 602 is supported by database server feature of a server 604 provided with front-end capabilities. In at least one embodiment, such database server features include those available from Oracle®, Microsoft®, Sybase®, IBM® (International Business Machines), and/or variations thereof.

In at least one embodiment, a server 604 is able to provide feeds and/or real-time updates for media feeds. In at least one embodiment, a server 604 is part of multiple server boxes spread over an area but functioning for a presently described process for analysis of a formation. In at least one embodiment, server 604 includes applications to measure network performance by network monitoring and traffic management. In at least one embodiment, a provided database 602 enables information storage from a wellsite, including user interactions, usage patterns information, adaptation rules information, and other information.

In at least one embodiment, a method and a system for determinations associated with pipe eccentricity in a downhole environment includes a downhole tool comprising first transducers and second transducers. The first transducers are on a first normal plane with respect to a longitudinal axis of a casing. The second transducers are on a second normal plane with respect to the longitudinal axis of a casing, and the method includes providing the downhole tool into the downhole environment. One or more of the first transducers are adapted to provide and receive shear horizontal waves and one or more of the second transducers are adapted to provide and receive Lamb waves, the shear horizontal waves and the Lamb waves are for at least one casing in the downhole environment. A processor of the system is adapted to determine shear horizontal third-interface echoes (TIEs) or Lamb TIEs from the shear horizontal waves or the Lamb waves received from the downhole environment. The system enables a method step for determining the pipe eccentricity based in part on the one or more of the 3 shear horizontal TIEs or the Lamb TIEs.

In at least one embodiment, another method and a system for determinations associated with pipe eccentricity in a downhole environment includes a downhole tool having first transducers and second transducers. The first transducers and the second transducers are to be stationary with respect to circumferential positions of a pipe for measurements associated with the pipe eccentricity at individual depths in the downhole. The method includes providing the downhole tool into the downhole environment. One or more of the first transducers are adapted to provide and receive shear horizontal waves and one or more of the second transducers are adapted to provide and receive Lamb waves, the shear horizontal waves and the Lamb waves are for at least one casing in the downhole environment. A processor of the system is adapted to determine shear horizontal third-interface echoes (TIEs) or Lamb TIEs from the shear horizontal waves or the Lamb waves received from the downhole environment. The system enables a method step for determining the pipe eccentricity based in part on the one or more of the shear horizontal TIEs or the Lamb TIEs.

In at least one embodiment, a still further method and a system for determinations associated with pipe eccentricity in a downhole environment includes a downhole tool having first transducers and second transducers. The method includes providing the downhole tool into the downhole environment. One or more of the first transducers are adapted to provide and receive shear horizontal waves and one or more of the second transducers are adapted to provide and receive Lamb waves, the shear horizontal waves and the Lamb waves are for at least one casing in the downhole environment. The first transducers and the second transducers are adapted to at least receive the shear horizontal waves and the Lamb waves from different circumferential locations of the downhole environment at a same time. A processor of the system is adapted to determine shear horizontal third-interface echoes (TIEs) or Lamb TIEs from the shear horizontal waves or the Lamb waves received from the downhole environment. The system enables a method step for determining the pipe eccentricity based in part on the one or more of the shear horizontal TIEs or the Lamb TIEs.

In at least one embodiment, a method and a system for determinations associated with pipe eccentricity in a downhole environment are disclosed. Such a system includes a downhole tool comprising first transducers and second transducers. The method includes providing the downhole tool into the downhole environment. One or more of the first transducers are adapted to provide and receive shear horizontal waves and one or more of the second transducers are adapted to provide and receive Lamb waves. The shear horizontal waves and the Lamb waves are for at least one casing in the downhole environment. A processor of the system is adapted to determine shear horizontal third-interface echoes (TIEs) or Lamb TIEs from the shear horizontal waves or the Lamb waves received from the downhole environment. The system enables a method step for determining the pipe eccentricity based in part on the one or more of the shear horizontal TIEs or the Lamb TIEs.

While techniques herein may be subject to modifications and alternative constructions, these variations are within spirit of present disclosure. As such, certain illustrated embodiments are shown in drawings and have been described above in detail, but these are not limiting disclosure to specific form or forms disclosed; and instead, cover all modifications, alternative constructions, and equivalents falling within spirit and scope of disclosure, as defined in appended claims.

Terms such as a, an, the, and similar referents, in context of describing disclosed embodiments (especially in context of following claims), are understood to cover both singular and plural, unless otherwise indicated herein or clearly contradicted by context, and not as a definition of a term. Including, having, including, and containing are understood to be open-ended terms (meaning a phrase such as, including, but not limited to) unless otherwise noted. Connected, when unmodified and referring to physical connections, may be understood as partly or wholly contained within, attached to, or joined together, even if there is something intervening.

Recitation of ranges of values herein are merely intended to serve as a shorthand method of referring individually to each separate value falling within range, unless otherwise indicated herein and each separate value is incorporated into specification as if it were individually recited herein. In at least one embodiment, use of a term, such as a set (for a set of items) or subset unless otherwise noted or contradicted by context, is understood to be nonempty collection including one or more members. Further, unless otherwise noted or contradicted by context, term subset of a corresponding set does not necessarily denote a proper subset of corresponding set, but subset and corresponding set may be equal.

Conjunctive language, such as phrases of form, at least one of A, B, and C, or at least one of A, B and C, unless specifically stated otherwise or otherwise clearly contradicted by context, is otherwise understood with context as used in general to present that an item, term, etc., may be either A or B or C, or any nonempty subset of set of A and B and C. In at least one embodiment of a set having three members, conjunctive phrases, such as at least one of A, B, and C and at least one of A, B and C refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, terms such as plurality, indicates a state of being plural (such as, a plurality of items indicates multiple items). In at least one embodiment, a number of items in a plurality is at least two but can be more when so indicated either explicitly or by context. Further, unless stated otherwise or otherwise clear from context, phrases such as based on means based at least in part on and not based solely on.

Operations of methods in FIGS. 5A-5D, and the sub-steps described herein can be performed in any suitable order unless otherwise indicated herein or otherwise clearly contradicted by context. In at least one embodiment, a method includes processes such as those processes described herein (or variations and/or combinations thereof) that may be performed under control of one or more computer systems configured with executable instructions and that may be implemented as code (e.g., executable instructions, one or more computer programs or one or more applications) executing collectively or exclusively on one or more processors, by hardware or combinations thereof.

In at least one embodiment, such code may be stored on a computer-readable storage medium. In at least one embodiment, such code may be a computer program having instructions executable by one or more processors. In at least one embodiment, a computer-readable storage medium is a non-transitory computer-readable storage medium that excludes transitory signals (such as a propagating transient electric or electromagnetic transmission) but includes non-transitory data storage circuitry (such as buffers, cache, and queues) within transceivers of transitory signals. In at least one embodiment, code (such as executable code or source code) is stored on a set of one or more non-transitory computer-readable storage media having stored thereon executable instructions (or other memory to store executable instructions) that, when executed (such as a result of being executed) by one or more processors of a computer system, cause computer system to perform operations described herein.

In at least one embodiment, a set of non-transitory computer-readable storage media includes multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—in at least one embodiment, a non-transitory computer-readable storage medium store instructions and a main central processing unit (CPU) executes some of instructions while other processing units execute other instructions. In at least one embodiment, different components of a computer system have separate processors and different processors execute different subsets of instructions.

In at least one embodiment, computer systems are configured to implement one or more services that singly or collectively perform operations of processes described herein and such computer systems are configured with applicable hardware and/or software that enable performance of operations. In at least one embodiment, a computer system that implements at least one embodiment of present disclosure is a single device or is a distributed computer system having multiple devices that operate differently such that distributed computer system performs operations described herein and such that a single device does not perform all operations.

In at least one embodiment, even though the above discussion provides at least one embodiment having implementations of described techniques, other architectures may be used to implement described functionality, and are intended to be within scope of this disclosure. In addition, although specific responsibilities may be distributed to components and processes, they are defined above for purposes of discussion, and various functions and responsibilities might be distributed and divided in different ways, depending on circumstances.

In at least one embodiment, although subject matter has been described in language specific to structures and/or methods or processes, it is to be understood that subject matter claimed in appended claims is not limited to specific structures or methods described. Instead, specific structures or methods are disclosed as example forms of how a claim may be implemented.

From all the above, a person of ordinary skill would readily understand that the tool of the present disclosure provides numerous technical and commercial advantages and can be used in a variety of applications. Various embodiments may be combined or modified based in part on the present disclosure, which is readily understood to support such combination and modifications to achieve the benefits described above.

What is claimed is:

1. A method for determining pipe eccentricity in a downhole environment, the method comprising:
providing a downhole tool comprising one or more first transducers to provide first shear horizontal waves and comprising one or more second transducers to provide first Lamb waves;
running the downhole tool into a casing to the downhole environment;
receiving, using the one or more first transducers, second shear horizontal waves that are associated with the first shear horizontal waves and that are returned from the downhole environment;
receiving, using the one or more second transducers, second Lamb waves that are associated with the first Lamb waves and that are returned from the downhole environment;
determining, using a processor executing instructions from a memory, shear horizontal third-interface echoes (TIEs) or Lamb TIEs from the second shear horizontal waves or the second Lamb waves; and
determining the pipe eccentricity of the casing based in part on the one or more of the shear horizontal TIEs or the Lamb TIEs.

2. The method of claim 1, further comprising:
providing the one or more first transducers on the downhole tool at a first position that is in a first normal plane with respect to a longitudinal axis of the casing; and
providing the one or more second transducers on the downhole tool at a second position that is in a second normal plane with respect to the longitudinal axis of a casing.

3. The method of claim 1, further comprising:
enabling the one or more first transducers and the one or more second transducers to be stationary with respect to circumferential positions of the casing for measurements associated with the pipe eccentricity at individual depths in the downhole environment.

4. The method of claim 1, wherein the second shear horizontal waves and the second Lamb waves comprise guided waves, the method further comprising:
determining the pipe eccentricity of the casing with respect to an outer casing or a formation of the downhole environment, based additionally on the guided waves.

5. The method of claim 4, wherein the pipe eccentricity of the casing is with respect to an outer casing or a formation of the downhole environment, based at least in part on the guided waves.

6. The method of claim 4, wherein the second shear horizontal waves and the second Lamb waves are associated with reflections from a third interface and wherein the guided waves are from leaked waves associated with the first Lamb waves that leak at least around a partial circumference of the downhole tool without interfacing with the casing.

7. The method of claim 1, further comprising:
enabling the one or more first transducers and the one or more second transducers to receive the second shear horizontal waves and the second Lamb waves from different circumferential locations of the downhole environment.

8. A system for determining pipe eccentricity in a downhole environment, the system comprising:
a downhole tool comprising one or more first transducers to provide first shear horizontal waves to a downhole environment and comprising one or more second transducers to provide first Lamb waves to the downhole environment;
memory storing instructions; and
a processor to execute the instructions from the memory to cause the system to:
receive, using the one or more first transducers, second shear horizontal waves that are associated with the first shear horizontal waves and that are returned from the downhole environment;
receive, using the one or more second transducers, second Lamb waves that are associated with the first Lamb waves and that are returned from the downhole environment;
determine, using a processor executing instructions from a memory, shear horizontal third-interface echoes (TIEs) or Lamb TIEs from the second shear horizontal waves or the second Lamb waves; and
determine the pipe eccentricity of the casing based in part on the one or more of the shear horizontal TIEs or the Lamb TIEs.

9. The system of claim 8, wherein the one or more first transducers is on the downhole tool at a first position that is in a first normal plane with respect to a longitudinal axis of the casing; and wherein the one or more second transducers is on the downhole tool at a second position that is in a second normal plane with respect to the longitudinal axis of a casing.

10. The system of claim 8, wherein the one or more first transducers and the one or more second transducers are to be stationary with respect to circumferential positions of the casing for measurements associated with the pipe eccentricity at individual depths in the downhole environment.

11. The system of claim 8, wherein the second shear horizontal waves and the second Lamb waves comprise guided waves and wherein the instructions that, when executed by the processor, further cause the system to:
determine the pipe eccentricity of the casing with respect to an outer casing or a formation of the downhole environment, based additionally on the guided waves.

12. The system of claim 11, wherein the pipe eccentricity of the casing is with respect to an outer casing or a formation of the downhole environment, based at least in part on the guided waves.

13. The system of claim 11, wherein the second shear horizontal waves and the second Lamb waves are associated with reflections from a third interface and wherein the guided waves are from leaked waves associated with the first Lamb waves that leak at least around a partial circumference of the downhole tool without interfacing with the casing.

14. The system of claim 8, wherein the one or more first transducers and the one or more second transducers are adapted to receive the second shear horizontal waves and the second Lamb waves from different circumferential locations of the downhole environment.

15. The system of claim 8, wherein one or more of the shear horizontal TIEs or the Lamb TIEs are with respect to a third interface associated with the casing or with a further barrier from the casing within the downhole environment.

16. The system of claim 8, wherein the one or more first transducers and the one or more second transducers first are electromagnetic acoustic transducers (EMAT) transducers with different measurement features to receive the second shear horizontal waves or the second Lamb waves.

17. A system comprising:
one or more processors to determine a pipe eccentricity of a casing in a downhole environment based in part on the one or more of shear horizontal third-interface echoes (TIEs) or Lamb TIEs, the shear horizontal TIEs or the Lamb TIEs determined from received shear horizontal waves or received Lamb waves, the received shear horizontal waves from one or more first transducers and the received Lamb waves from the one or more second transducers, the one or more first transducers to provide shear horizontal waves from a downhole tool into the casing of the downhole environment and to cause the received shear horizontal waves and the one or more second transducers to provide Lamb waves from the downhole tool into the casing to cause the received Lamb waves.

18. The system of claim 17, wherein the received shear horizontal waves and the received Lamb waves comprise guided waves and wherein the one or more processors are further to:
determine the pipe eccentricity of the casing with respect to an outer casing or a formation of the downhole environment, based additionally on the guided waves.

19. The system of claim 18, wherein the pipe eccentricity of the casing is with respect to an outer casing or a formation of the downhole environment, based at least in part on the guided waves.

20. The system of claim 18, wherein the second shear horizontal waves and the second Lamb waves are associated with reflections from a third interface and wherein the guided waves are from leaked waves associated with the first Lamb waves that leak at least around a partial circumference of the downhole tool without interfacing with the casing.
